(19) United States
(12) Patent Application Publication
(10) Pub. No.: US 2013/0112021 A1
(43) Pub. Date: May 9, 2013

(54) Numerically Controlled Tower Type Combination Drive Pumping Unit

(71) Applicant: Hongwei Mao, Beijing (CN)

(72) Inventor: Hongwei Mao, Beijing (CN)

(21) Appl. No.: 13/810,166

(22) PCT Filed: Jul. 13, 2011
(86) PCT No.: PCT/CN2011/077098

§ 371 Date: Jan. 14, 2013

(30) Foreign Application Priority Data
Jul. 15, 2010 (CN) 201010227310.9
Jul. 15, 2010 (CN) 201020259325.9
Apr. 19, 2011 (CN) 201120115400.9
Jun. 13, 2011 (CN) 201110157108.8
Jun. 13, 2011 (CN) 201120197608.X

(51) Int. Cl. F16H 19/06

(52) U.S. Cl. CPC F16H 19/06
USPC 74/89.22

(57) ABSTRACT

A numerical controlled combination drive tower pumping unit includes a main tower frame, a power system, a drive system, a control system, a balance weight box, a balance weight pull rope, a wire rope wheel, a drive rope, and a wire rope hanger. The control system is connected to the power system to control the speed and the reversing position of the power system. The power system is mechanically connected to the wire rope wheel. The wire rope wheel is mounted on a wire rope wheel shaft. Two ends of the wire rope wheel shaft are placed on the wire rope wheel support and are respectively installed in two roller wheels. The wire rope wheel shaft or two roller wheels are placed on a rolling plane. There are limiting blocks at both ends of the rolling plane, and there are also locating blocks to fix the roller wheels.

### CROSS REFERENCE OF RELATED APPLICATION

This is a U.S. National Stage under 35 U.S.C 371 of the International Application PCT/CN2011/077098, filed Jul. 13, 2011.

### BACKGROUND OF THE PRESENT INVENTION

1. Field of Invention

This invention is related to an Oil Extraction Mechanical Equipment, especially to a Tower Type Oil Pumping Unit.

2. Description of Related Arts

Currently, in oil extracting field, the Beam Pumping Units are gradually replaced by Tower Type Oil Pumping Units resulting from their benefits of simple structure, simple operation and maintenance, low unit cost, and low energy consumption. An Utility Patent application No. 2008102388641.1 has been published in China on a Combination Drive Tower Pumping Unit. The drive system of the unit employed belt, chain, or combinations of belt and chain with permanent magnet synchronized braking motor of low speed and large torque to transfer mechanical power to the first transfer shaft in the first stage speed reduction and to a second stage speed reduction via a pair of gears to cause the drive wire rope and balance weight pull rope, that are wrap fastened to the wire rope wheel, thus the sucker rods and balance weight box to make an up and down movements to accomplish oil pumping tasks. The benefits of using chain or belt and chain combination to achieve the first stage speed reduction are reducing mechanical power loss, maintaining higher operating efficiency under large load, and reducing noise level in environment sensitive area. The drawback of the Tower Pumping Unit is the added efforts and low work efficiency during oil well work-over which requires to move the wire rope wheel, weighing several tons for large diameter wheel, away from its working position.

### SUMMARY OF THE PRESENT INVENTION

This invention is to solve the technical problem by providing a Numerically Controlled Tower Pumping Unit with Combination Drive using a simple structure and easily movable wire rope wheel during the oil well work-over.

This invention of a Numerically Controlled Tower Type Combination Drive Pumping Unit includes a main tower frame, a power system, a drive system, a control system, a balance weight box, a balance weight wire rope, a wire rope wheel, a drive wire rope, and a wire rope hanger. The power system, the drive system, the control system, and the wire rope wheel are all placed on an operating platform at a top of the main tower frame. The control system is electrically connected to the power system to control the speed and the reversing position of the power system; the power system is mechanically connected to the wire rope wheel via the drive system; the wire rope wheel is mounted either via taper roller bearings or directly on the wire rope wheel shaft; two ends of the wire rope wheel shaft are fastened respectively on two split body bearing seats, bearing seats are installed on the wire rope wheel supports, taper roller bearings are installed on two sides of the wire rope wheel or the wire rope wheel shaft, the wire rope wheel shaft or roller wheels are roll-able on the flat rolling surface of the lengthened wire rope wheel supports. One position limiting plate is placed at each end of the rolling plane which also has a locating block to fasten the roller wheels.

In this invention of Numerically Controlled Tower Type Combination Drive Pumping Unit, the locating block has a circular arc contacting surface to match the surface of the roller wheel or the wire rope wheel shaft.

In this invention of Numerical Controlled Tower Type Combination Drive Pumping Unit, the locating block is fastened to the rolling plane by dismountable bolts.

In this invention of a Numerically Controlled Tower Type Combination Drive Pumping Unit, the roller wheel has an outer pressure cover installed on the outer side of the roller wheel and has an inner pressure cover installed on the inner side of the roller wheel through the wire rope wheel shaft.

In this invention of a Numerically Controlled Tower Type Combination Drive Pumping Unit, the drive system includes a small pulley, a large pulley, a speed reducer or a first drive shaft, a small sprocket, and a large sprocket; wherein the small pulley is fastened on an output shaft of the power system; the large pulley and the small sprocket are fastened on an input shafts and an output shafts of the speed reducer respectively, belts are installed on the small pulley and large pulley; the large sprocket is fastened coaxially on one side of the wire rope wheel; and the small sprocket and the large sprocket are dynamically connected via a chain.

In this invention of a Numerically Controlled Tower Type Combination Drive Pumping Unit, the drive system includes a small gear, a large gear, a first drive shaft, a small sprocket and a large sprocket; wherein the small gear is fastened on an output shaft of the power system; the first drive shaft is placed on the operating platform via a shaft seat; the large gear and small sprocket are fastened respectively on two ends of the first drive shaft; the large gear meshed with small gear; the large sprocket and the wire rope wheel are fastened correspondingly on the wire rope wheel shaft; and the small sprocket and the large sprocket are dynamically connected via a chain.

In this invention of a Numerically Controlled Tower Type Combination Drive Pumping Unit, the drive system includes a small pulley, a large pulley, a first drive shaft, a small sprocket and a large sprocket; the small pulley is fastened on an output shaft of the power system; the first drive shaft is placed on the operating platform via a shaft seat; the large pulley and small sprocket are fastened respectively on two ends of the first drive shaft; the large pulley and the small pulley are dynamically connected via belt, the large sprocket and the wire rope wheel are fastened correspondingly on the wire rope wheel shaft; the small sprocket and the large sprocket are dynamically connected via a chain.

This invention of a Numerically Controlled Tower Type Combination Drive Pumping Unit differentiated from current technology in placing the wire rope wheel shaft or the roller wheel on the rolling plane on top of the wire rope wheel support via the wire rope wheel shaft or the roller wheel, allowing the wire rope wheel shaft or the roller wheels to roll on the rolling plane, the limiting plates and the locating blocks can fasten the wire rope wheel shaft or the roller wheels to two ends of the rolling plane. It only requires to un-fasten the locating blocks and push the wire rope wheel shaft or the roller wheels to roll to one end of the rolling plane to allow oil well work-over space. This movement can be manually achieved with operational simplicity, time and labor saving due to the smaller rolling friction resulting smaller need of force to push the roller wheels.

Further illustrations are made for the operation of this invention of Numerically Controlled Tower Pumping Unit with Combination Drive in combination of following drawings.

### BRIEF DESCRIPTION OF THE DRAWINGS

FIG. 1 is the Main View of a Numerically Controlled Tower Type Combination Drive Pumping Unit according to the first Embodiment of this Invention.

FIG. 2 is the Top View of the Numerically Controlled Tower Type Combination Drive Pumping Unit according to the first Embodiment of this Invention.

FIG. 3 is the Side Cutout View of the Wire Rope Wheel of the Numerically Controlled Tower Type Combination Drive Pumping Unit according to the first Embodiment of this Invention.

FIG. 4 is the Top View of the Numerically Controlled Tower Type Combination Drive Pumping Unit according to the second Embodiment of this Invention.

FIG. 5 is the Top View of the Numerically Controlled Tower Type Combination Drive Pumping Unit according to the third Embodiment of this Invention.

### DETAILED DESCRIPTION OF THE PREFERRED EMBODIMENT

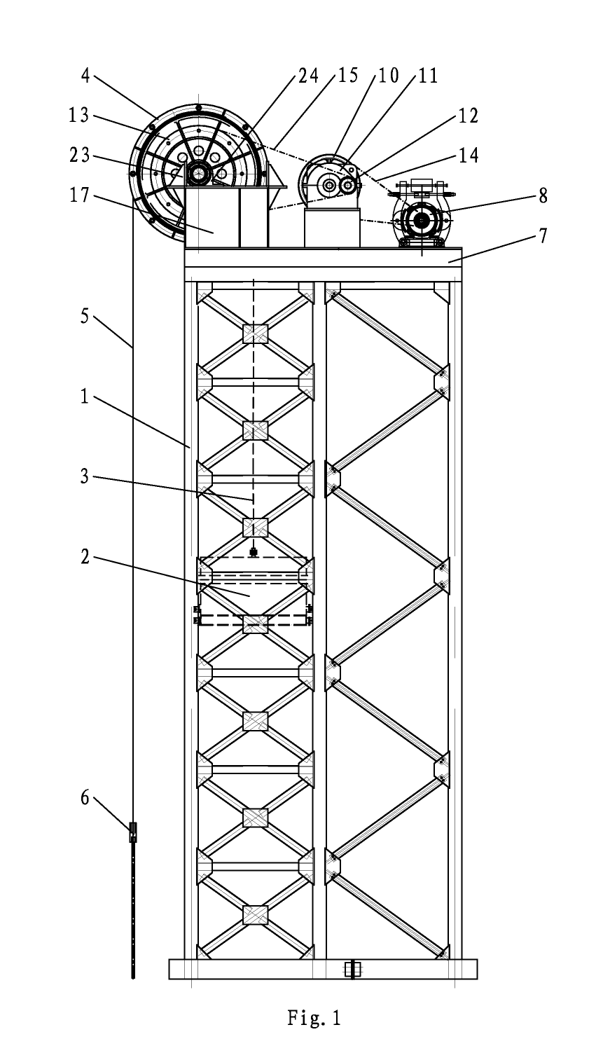

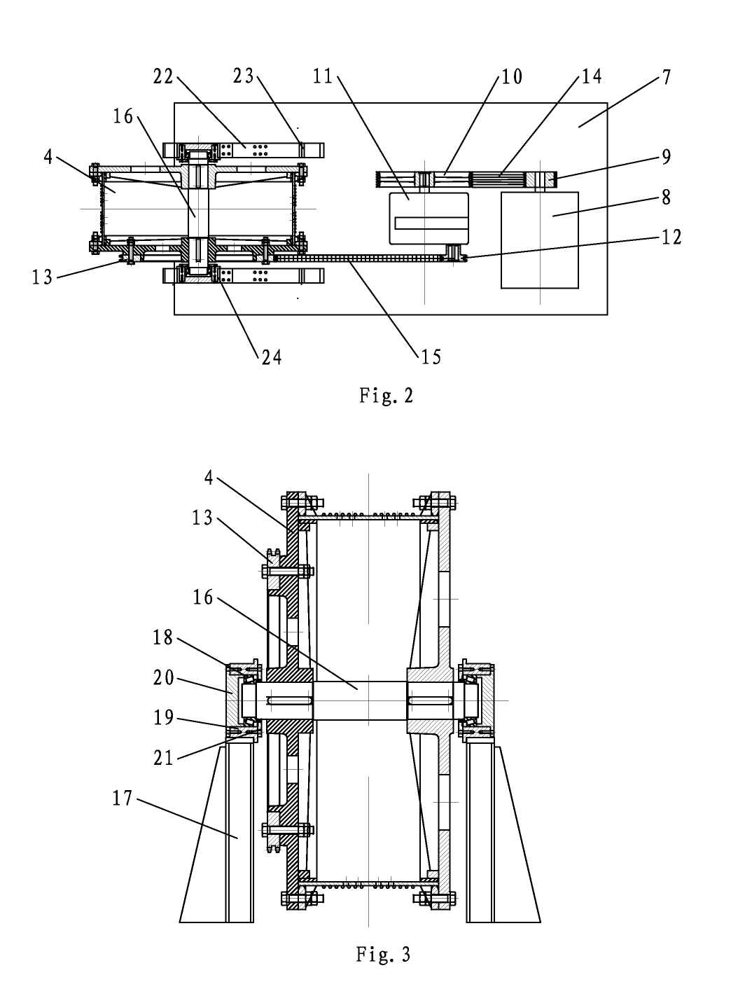

As FIG. 1 and FIG. 2 indicate, the first embodiment of this invention of Numerically Controlled Tower Pumping Unit with Combination Drive includes a main tower frame 1, a power system, a drive system, a control system, a balance weight box 2, a balance weight pull rope 3, a wire rope wheel 4, a drive wire rope 5, and a wire rope hanger 6. The power system, the drive system, the control system, and the wire rope wheel 4 are all installed on an operation platform 7 at the top of the main tower frame 1, the control system is electrically connected to the power system, the power system used a motor 8, the control system controls the reversing position and speed of the motor 8, the motor 8 is dynamically connected to the wire rope wheel 4 via the drive system. The drive system includes a small pulley 9, a large pulley 10, a speed reducer 11, a small sprocket 12, and a large sprocket 13, the small pulley 9 is fastened to an output shaft of the motor 8, the large pulley 10 and the small sprocket 12 are fastened respectively on input and output shafts of the speed reducer 11, a belt 14 is installed on the large pulley 10 and the small pulley 9, the large sprocket 13 is fastened coaxially to one side of the wire rope wheel 4, the small sprocket 12 and the large sprocket 13 are dynamically connected via a chain 15.

As the FIG. 3 indicates, the wire rope wheel 4 is fastened to the wire rope wheel shaft 16, two ends of wire rope wheel shaft 16 are installed on the wire rope wheel supports 17 and are installed respectively in two roller wheels 19 via taper roller bearings 18, a roller wheel outer pressure cover 20 is fastened on the outer side of roller wheel 19 with bolts, a roller wheel inner pressure cover 21 is fastened with bolts on the inner side of roller wheel 19 encasing the wire rope wheel shaft 16. The two roller wheels 19 are placed on the rolling plane 22 of the wire rope wheel support 17, limiting plates 23 are set respectively at two ends of the rolling plane 22, there are also locating blocks 24 to fix the roller wheels 19 on the rolling plane 22, locating blocks 24 possessed a circular arc shaped contacting surface with the surface of the roller wheel 19, and locating blocks 24 are fastened on the rolling plane 22 via dismountable bolts.

When the oil well work-over space is needed, unfasten the locating blocks 24 from rolling plane 22, push the wire rope wheel 4 to roll the roller wheels 19 to the rear along the rolling plane 22, then fasten the locating blocks 24 on the rolling plane 22 when the roller wheels 19 are in contact with the rear limiting plates 24.

As FIG. 4 indicates, the 2nd embodiment of this invention of Numerically Controlled Tower Pumping Unit with Combination Drive differentiates from the first embodiment of the invention lies in the drive system, the drive system includes a small gear 9′, a large gear 10′, a first drive shaft 11′, a small sprocket 12′, and a large sprocket 13′, wherein the small gear 9′ is fastened to an output shaft of a motor 8′, the first drive shaft 11′ is installed on an operation platform 7′ via a shaft seat, the large gear 10′ and the small sprocket 12′ are fastened respectively at two ends of the first drive shaft 11′, the large gear 10′ meshed with the small gear 9′, the large sprocket 13′ and the wire rope wheel 4′ are fastened correspondingly on the wire rope wheel shaft 16′, and the small sprocket 12′ and the large sprocket 13′ are dynamically connected via chain 15′.

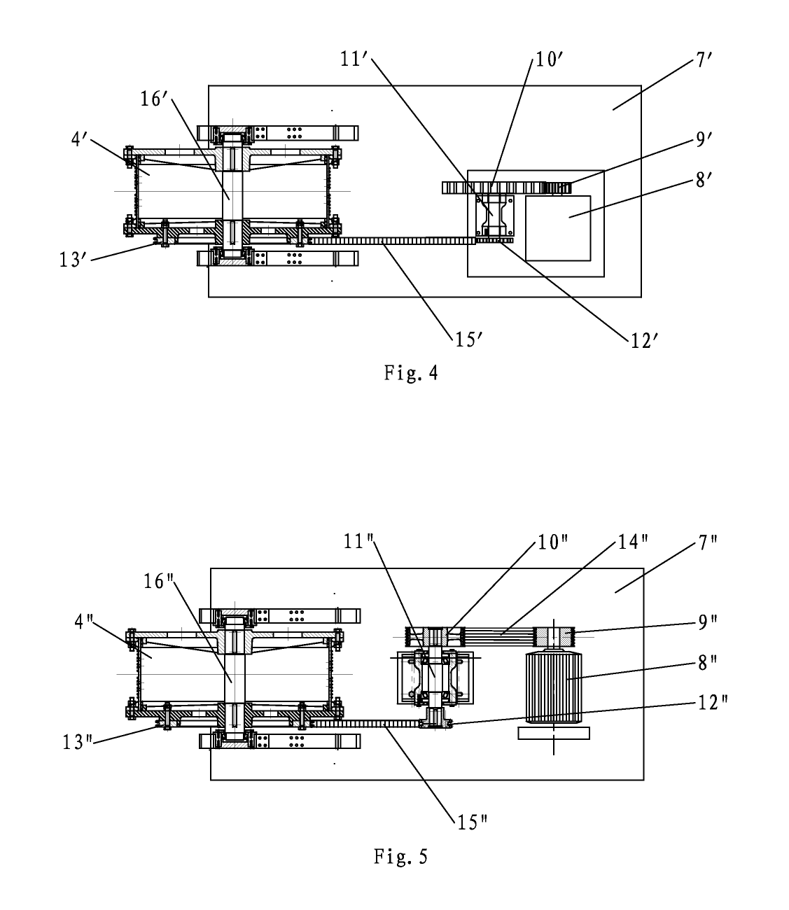

As FIG. 5 indicates, the 3rd embodiment of this invention of Numerically Controlled Tower Pumping Unit with Combination Drive differentiates from the first embodiment of the invention lies in the drive system. The drive system includes a small pulley 9″, a large pulley 10″, a first drive shaft 11″, a small sprocket 12″, and a large sprocket 13″, wherein the small pulley 9″ is fastened to an output shaft of a motor 8″, the first drive shaft 11″ is installed on an operation platform 7″ via a shaft seat, the large pulley 10″ and the small sprocket 12″ are fastened respectively at two ends of the first drive shaft 11″, the large pulley 10″ and the small pulley 9″ are dynamically connected via a belt 14″, the large sprocket 13″ and the wire rope wheel 4″ are fastened correspondingly on the wire rope wheel shaft 16″, the small sprocket 12″ and the large sprocket 13″ are dynamically connected via a chain 15″.

### Technical Utility

The Numerical Controlled Tower Type Combination Drive Pumping Unit has strong industrial utility by raising the mobility of the wire rope wheel of the tower pumping unit and reducing the labor intensity during the oil well work-over.

1-7. (canceled)

8. A Numerically Controlled Tower Type Combination Drive Pumping Unit which includes a main tower frame, a power system, a drive system, a control system, a balance weight box, a balance weight pull rope, a wire rope wheel, a drive wire rope, and a wire rope hanger; wherein the power system, the drive system, the control system, and the wire rope wheel are installed on an operation platform at the top of the main tower frame; the control system is connected to the power system to control a speed and a reversing position of the power system; the power system is connected dynamically with the wire rope wheel through the drive system; the wire rope wheel is fastened to the wire rope wheel shaft; two ends of the wire rope wheel shaft or roller wheels are fastened to the split body bearing seat placed on the wire rope wheel supports; the special feature of this invention lies on that the lengthened support installation allows the wire rope wheel shaft or the roller wheels to move back and forth on the flat rolling plane; Limiting plates are installed at both ends of the rolling plane, and position locating blocks are also installed on the rolling plane to fasten the roller wheels.

9. The Numerically Controlled Tower Type Combination Drive Pumping Unit in claim 8, wherein a contacting surface of circular arc on the locating block matches the surface of the roller wheel.

10. The Numerically Controlled Tower Type Combination Drive Pumping Unit in claim 9, wherein the locating blocks are fastened on the rolling plane by bolts that are dismount-able.

11. The Numerically Controlled Tower Type Combination Drive Pumping Unit in claim 10, wherein an outer pressure cover is mounted on an outside of the roller wheel and an inner pressure cover is mounted on an inner side of the roller wheel through the wire rope wheel shaft.

12. The Numerically Controlled Tower Type Combination Drive Pumping Unit in claim 8, wherein the drive system includes a small pulley, a large pulley, a speed reducer, a small sprocket, and a large sprocket; the small pulley is fastened on an output shaft of the power system; the large pulley and the small sprocket are respectively fastened on an input shaft and an output shaft of the speed reducer with belt installed on both pulleys; the large sprocket coaxially fastened on one side of the wire rope wheel; the small sprocket and the large sprocket are dynamically connected by chain.

13. The Numerically Controlled Tower Type Combination Drive Pumping Unit in claim 9, wherein the drive system includes a small pulley, a large pulley, a speed reducer, a small sprocket, and a large sprocket; the small pulley is fastened on an output shaft of the power system; the large pulley and the small sprocket are respectively fastened on an input shaft and an output shaft of the speed reducer with belt installed on both pulleys; the large sprocket coaxially fastened on one side of the wire rope wheel; the small sprocket and the large sprocket are dynamically connected by chain.

14. The Numerically Controlled Tower Type Combination Drive Pumping Unit in claim 10, wherein the drive system includes a small pulley, a large pulley, a speed reducer, a small sprocket, and a large sprocket; the small pulley is fastened on an output shaft of the power system; the large pulley and the small sprocket are respectively fastened on an input shaft and an output shaft of the speed reducer with belt installed on both pulleys; the large sprocket coaxially fastened on one side of the wire rope wheel; the small sprocket and the large sprocket are dynamically connected by chain.

15. The Numerically Controlled Tower Type Combination Drive Pumping Unit in claim 11, wherein the drive system includes a small pulley, a large pulley, a speed reducer, a small sprocket, and a large sprocket; the small pulley is fastened on an output shaft of the power system; the large pulley and the small sprocket are respectively fastened on an input shaft and an output shaft of the speed reducer with belt installed on both pulleys; the large sprocket coaxially fastened on one side of the wire rope wheel; the small sprocket and the large sprocket are dynamically connected by chain.

16. The Numerically Controlled Tower Type Combination Drive Pumping Unit in claim 8, wherein the drive system includes a small gear, a large gear, a first drive shaft, a small sprocket and a large sprocket; the small gear is fastened to an output shaft of the power system; the first drive shaft is installed on an operating platform via a first drive shaft seat; the large gear and the small sprocket are fastened to two ends of the first drive shaft respectively; the large gear meshed with the small gear; the large sprocket and the wire rope wheel are correspondingly fastened onto the wire rope wheel shaft; the small sprocket and the large sprocket are connected by a chain.

17. The Numerically Controlled Tower Type Combination Drive Pumping Unit in claim 9, wherein the drive system includes a small gear, a large gear, a first drive shaft, a small sprocket and a large sprocket; the small gear is fastened to an output shaft of the power system; the first drive shaft is installed on an operating platform via a first drive shaft seat; the large gear and the small sprocket are fastened to two ends of the first drive shaft respectively; the large gear meshed with the small gear; the large sprocket and the wire rope wheel are correspondingly fastened onto the wire rope wheel shaft; the small sprocket and the large sprocket are connected by a chain.

18. The Numerically Controlled Tower Type Combination Drive Pumping Unit in claim 10, wherein the drive system includes a small gear, a large gear, a first drive shaft, a small sprocket and a large sprocket; the small gear is fastened to an output shaft of the power system; the first drive shaft is installed on an operating platform via a first drive shaft seat; the large gear and the small sprocket are fastened to two ends of the first drive shaft respectively; the large gear meshed with the small gear; the large sprocket and the wire rope wheel are correspondingly fastened onto the wire rope wheel shaft; the small sprocket and the large sprocket are connected by a chain.

19. The Numerically Controlled Tower Type Combination Drive Pumping Unit in claim 11, wherein the drive system includes a small gear, a large gear, a first drive shaft, a small sprocket and a large sprocket; the small gear is fastened to an output shaft of the power system; the first drive shaft is installed on an operating platform via a first drive shaft seat; the large gear and the small sprocket are fastened to two ends of the first drive shaft respectively; the large gear meshed with the small gear; the large sprocket and the wire rope wheel are correspondingly fastened onto the wire rope wheel shaft; the small sprocket and the large sprocket are connected by a chain.

20. The Numerically Controlled Tower Type Combination Drive Pumping Unit in claim 8, wherein the drive system includes a small pulley, a large pulley, a first drive shaft, a small sprocket and a large sprocket; the small pulley is fastened to an output shaft of the power system; the first drive shaft is installed on an operating platform via a first drive shaft seat; the large pulley and the small sprocket are fastened to two ends of the first drive shaft respectively; the large pulley and the small pulley are connected by a belt; the large sprocket and the wire rope wheel are correspondingly fastened onto the wire rope wheel shaft; the small sprocket and the large sprocket are connected by a chain.

21. The Numerically Controlled Tower Type Combination Drive Pumping Unit in claim 9, wherein the drive system includes a small pulley, a large pulley, a first drive shaft, a small sprocket and a large sprocket; the small pulley is fastened to an output shaft of the power system; the first drive shaft is installed on an operating platform via a first drive shaft seat; the large pulley and the small sprocket are fastened to two ends of the first drive shaft respectively; the large pulley and the small pulley are connected by a belt; the large sprocket and the wire rope wheel are correspondingly fastened onto the wire rope wheel shaft; the small sprocket and the large sprocket are connected by a chain.

22. The Numerically Controlled Tower Type Combination Drive Pumping Unit in claim 10, wherein the drive system includes a small pulley, a large pulley, a first drive shaft, a small sprocket and a large sprocket; the small pulley is fastened to an output shaft of the power system; the first drive shaft is installed on an operating platform via a first drive shaft seat; the large pulley and the small sprocket are fastened to two ends of the first drive shaft respectively; the large pulley and the small pulley are connected by a belt; the large sprocket and the wire rope wheel are correspondingly fastened onto the wire rope wheel shaft; the small sprocket and the large sprocket are connected by a chain.

23. The Numerically Controlled Tower Type Combination Drive Pumping Unit in claim 11, wherein the drive system includes a small pulley, a large pulley, a first drive shaft, a small sprocket and a large sprocket; the small pulley is fastened to an output shaft of the power system; the first drive shaft is installed on an operating platform via a first drive shaft seat; the large pulley and the small sprocket are fastened to two ends of the first drive shaft respectively; the large pulley and the small pulley are connected by a belt; the large sprocket and the wire rope wheel are correspondingly fastened onto the wire rope wheel shaft; the small sprocket and the large sprocket are connected by a chain.
